(19) United States
(12) Patent Application Publication
(10) Pub. No.: US 2017/0145146 A1
(43) Pub. Date: May 25, 2017

(54) RENEWABLY DERIVED THERMOPLASTIC POLYESTER-BASED URETHANES AND METHODS OF MAKING AND USING THE SAME

(71) Applicant: Trent University, Peterborough (CA)

(72) Inventors: Suresh Narine, Peterborough (CA); Shegufta Shetranjiwalla, Peterborough (CA); Shaojun Li, Peterborough (CA); Laziz Bouzidi, Peterborough (CA)

(21) Appl. No.: 15/361,184

(22) Filed: Nov. 25, 2016

Related U.S. Application Data
(60) Provisional application No. 62/259,754, filed on Nov. 25, 2015.

(51) Int. Cl. C08G 18/42; C08G 18/76

(52) U.S. Cl. CPC C08G 18/4238; C08G 18/7671

(57) ABSTRACT

The disclosure generally provides high-molecular-weight thermoplastic polyester-based urethanes (TPEUs). In some embodiments, the component monomers of the TPEUs are entirely derived from renewable sources. The disclosure also provides methods of making high-molecular-weight TPEUs, and, in particular, methods for achieving such high molecular weights. The disclosure also provides certain uses of such TPEUs.

High molecular weight, semi-crystalline TPEU elastomers were synthesized from polyester diols (PEDs) and 1,7 heptamethylene diisocyanate (HPMDI) both derived from oleic acid. Functional group stoichiometry and polymerization time were used as tools to control molecular weight and optimize the thermal and mechanical properties of the TPEU. A targeted range of PEDs with controlled molecular weights and narrow polydispersity indices were obtained in high yields using an induced stoichiometric imbalance method. The PEDs were reacted with HPMDI with different NCO:OH ratios (1.1 to 2.1) and polymerization times (2 to 24 hours) in order to obtain high molecular weight TPEUs. Solvent-resistant TPEUs, displaying polyethylene-like behavior with controlled polyester and urethane segment phase separation were obtained and characterized by FTIR, ¹H-NMR, GPC, DSC, TGA and tensile tests in order to reveal the structure-property relationships. Melting and glass transition temperatures, tensile strength and maximum strain increased with molecular weight approaching saturation values, demonstrating a plateau effect of molecular weight on physical properties. The novel TPEUs showed extensive degradation under hydrothermal ageing in water at 80° C. and achieved a tensile half-life in one day of immersion. The entirely lipid-derived TPEUs exhibited thermal and mechanical properties comparable to commercially available entirely petroleum-based analogues.

### CROSS-REFERENCE TO RELATED APPLICATIONS

The present application claims the benefit of priority from U.S. provisional application No. 62/259,754 filed on Nov. 25, 2015, the contents of which are incorporated herein by reference in their entirety.

### TECHNICAL FIELD

The disclosure generally provides high-molecular-weight thermoplastic polyester-based urethanes (TPEUs). In some embodiments, the component monomers of the TPEUs are entirely derived from renewable sources. The disclosure also provides methods of making high-molecular-weight TPEUs, and, in particular, methods for achieving such high molecular weights. The disclosure also provides certain uses of such TPEUs.

### DESCRIPTION OF RELATED ART

Linear thermoplastic TPEU elastomers are an attractive class of materials due to their elastic properties and reprocess-ability at melt. TPEUs are used in a wide variety of applications ranging from automotive parts and building construction to footwear, wire and cable insulation jackets, and biomedical devices. TPEUs are copolymers of polyester diols (PEDs) and diisocyanates, and can demonstrate a versatile combination of chemical and physical properties such as biodegradability, flexibility, resistance to dilute acids and alkalis, thermal stability and mechanical strength. Recently, triacylglycerol (TAG) oil derivatives have received much attention as potential substitutes for petroleum for the synthesis of the polyurethane monomers including isocyanates constituents. However, in contrast to their petroleum based counterparts, TPEUs derived from vegetable oils have shown low molecular weight and poor mechanical and thermal properties due to the inherent structure and reactivity limitations of the TAG molecule.

The mechanical and thermal properties of a polymer such as the tensile strength and modulus, elongation, melt and glass transition temperatures are a function of molecular weight. At high molecular weight and above a critical value, the physical properties eventually attain a saturation value. The molecular weight of TPEUs and subsequent properties depends on the structure and molecular weight of the urethane and the polyester segments, their functional group stoichiometry (NCO:OH ratio) and polymerization time.

The PED soft segments form the major component of TPEUs and strongly affect its crystal structure and therefore properties. The molecular weight and molecular weight distribution of PEDs is critical. PEDs with molecular weight in the range of 1000 and 6000 g/mol can be used to obtain certain thermal and mechanical properties. PEDs can be synthesized from lipid-derived diacid and diol monomers by solvent-free melt-condensation. However, molecular weight control of polyesters by melt-condensation is difficult. It is complicated by inter- and intramolecular side-reactions that lead to the formation of low molecular weight polyesters with cyclic by-products and low yields. Additionally, in the case of bifunctional molecules, the competing polyesterification reactions cause a shift in functional group stoichiometry resulting in polyesters with mixed end-groups; rendering them unsuitable as precursors for subsequent synthesis.

The control of polymerization time is also important for achieving specific molecular weight, since it determines the degree of polyesterification. Therefore, for the successful synthesis of PEDs without mixed-end groups and specified molecular weights, an effective control of diacid:diol functional group stoichiometry and reaction time is essential. Kinetic studies on melt-condensation polyesterification have indicated that an initial diacid:diol stoichiometric ratio closer to unity, a high catalyst concentration and a range of high temperatures result in linear polyesters with high molecular weight and yields. Specific molecular weights have also been achieved by using a monofunctional monomer to terminate the reaction at a selected time. However, the resultant polymers were unsuitable for further reaction because of their mixed end-groups composition.

The synthesis of linear TPEUs is also complicated by the rate of reaction of the diisocyanate with the PED; wherein the reactivity of the second NCO group of the diisocyanate varies when the first NCO group has reacted. Furthermore, the possible diisocyanate side-reactions, such as allophanate formation, or the reaction with atmospheric moisture, lead to a decrease in the effective NCO:OH ratio during synthesis, resulting in a low degree of polymerization.

Thus, there is a continuing need to develop new approaches to making TPEUs that can overcome one or more of the aforementioned problems.

### SUMMARY

In the present disclosure, hydroxyl-terminated linear PEDs of target molecular weight between 1000 and 6000 g/mol with narrow polydispersity indices (PDIs) were achieved in high yields by varying functional group stoichiometry and reaction time. Diacid and diol monomers were reacted with an initial stoichiometric imbalance, and in order to end-cap the polyesters with hydroxyl groups and mitigate polymerization, a further stoichiometric imbalance was induced by adding extra diol at selected reaction times. Two series of TPEUs were prepared from the PEDs and lipid derived HPMDI. The NCO:OH ratio and polymerization time were optimized in order to achieve molecular weights above the critical value at which the TPEUs properties would reach saturation. The TPEUs were fully characterized for molecular weight, structural morphology, solubility and thermal and mechanical properties.

The TPEUs disclosed herein are of high molecular weight, possessing weight average molecular weight (M_{w}) greater than 625,000 g/mol. Until now, entirely lipid-derived TPEUs of molecular weights greater than weight average molecular weights of 53,000 g/mol have not been reported. The TPEUs disclosed herein are the first reported entirely lipid-derived TPEU elastomers (e.g., elongation greater than 100%). For example, certain TPEUs disclosed herein started to show elastomeric properties with the TPEU made with an NCO:OH=2.1 and M_{w}=44,000 which has an elongation of 223%. In some embodiments, optimization of functional group stoichiometry for the monomer PEDs is disclosed for achieving controlled molecular weight. In some embodiments, optimization of reaction time for the monomer PEDs is disclosed for achieving controlled molecular weight using: a combination of initial and induced stoichiometric imbalance at specific reaction times from 1 hour to 7 hours for the starting diacids and diols of PEDs. Further, in some embodiments, optimization of functional group stoichiometry for the TPEU elastomers is disclosed for achieving high molecular weight by: optimization of PED and HPMDI functional group stoichiometry (for example, in some such embodiments, NCO:OH ratio 1.1-2.1). Further, in some embodiments, optimization of polymerization time for the TPEU elastomers is presented for achieving high molecular weight by: variation of polymerization time from 2 hours to 24 hours. In some embodiments, a maximum strain (e.g., 353%) is disclosed that is superior to all other entirely lipid-derived TPEUs previously reported. In some embodiments, solvent-resistant TPEUs are disclosed, for example, TPEUs that are not soluble in a range of organic solvents with different polarities such as chloroform, tetrahydrofuran (THF), and dimethylformamide (DMF), which are common organic solvents for processing polyurethanes at room temperature or at the solvent boiling point. In some embodiments, TPEUs having intermolecular bonding dominated by van der Waals forces that dilute the effect of the hydrogen bonding forces are disclosed.

In some embodiments, the entirely lipid-derived TPEU elastomers of this present disclosure have superior molecular weight, thermal and mechanical proprieties in comparison to TPEUs reported in the literature with a similar structure, for example, TPEUs reported in Hojabri et al, Polymer, vol. 53, pp. 3762-3771 (2012), which possess molecular weights below 53,000 g/mol and maximum strain lower than 12%.

In some embodiments, the thermal and mechanical properties of the entirely lipid-derived TPEUs of the present work are superior to entirely lipid-derived TPEUs previously synthesized with PED and HPMDI. In some embodiments, the thermal and mechanical properties of the entirely lipid-derived TPEUs of the present work are comparable to the properties of commercial TPEUs. In some embodiments, the glass transition temperature of the TPEUs of the present disclosure (e.g., PU2.1 at 24 hours) is comparable to other commercially available renewable polyester-based TPEUs. In some embodiments, the elongation at break of the TPEUs of the present work (353%) is also comparable to that of certain commercially available renewable polyester-based TPEUs.

In a first aspect, the disclosure provides polymer compositions, comprising one or more polymers having constitutional units according to formula (I):

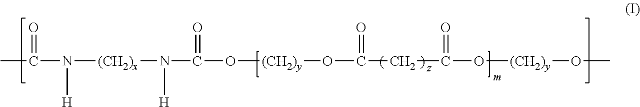

wherein: x is an integer from 2 to 40; y is an integer from 9 to 22; z is an integer from 7 to 22; and m is an integer from 2 to 50; wherein the one or more polymers in the composition have a weight-average molecular weight (M_{w}) of at least 44,000 g/mol.

In a second aspect, the disclosure provides polymer compositions, comprising one or more urethane polymers formed from a first reaction mixture, which comprises C₂₋₄₀ diisocyanates and dihydroxyl-terminated polyesters; wherein the dihydroxyl-terminated polyesters are formed from a second reaction mixture, which comprises C₉₋₂₂ diols and C₇₋₂₂ dicarboxylic acids or esters thereof; and wherein the dihydroxyl-terminated polyesters in the first reaction mixture have a number-average molecular weight (Mₙ) of at least 3000 g/mol.

Further aspects and embodiments are disclosed in the Detailed Description.

### BRIEF DESCRIPTION OF THE DRAWINGS

The following drawings are provided for purposes of illustrating various embodiments of the compounds, compositions, and methods disclosed herein. The drawings are provided for illustrative purposes only, and are not intended to describe any preferred compounds, preferred compositions, or preferred methods, or to serve as a source of any limitations on the scope of the claimed inventions.

FIG. 1 shows constitutional unit of polyurethanes disclosed in certain embodiments herein, wherein x is an integer from 2 to 40; y is an integer from 9 to 22; z is an integer from 7 to 22; and m is an integer from 2 to 50.

FIG. 2 shows a synthetic scheme corresponding to certain embodiments of making polyester diols disclosed herein.

FIG. 3 shows a synthetic scheme corresponding to certain embodiments of making poly (ester urethanes) disclosed herein.

FIG. 4 shows the ¹H NMR spectrum for a PED composition disclosed herein.

FIG. 5 shows (a) GPC curves of PED-3h obtained at different reaction times, and (b) relative conversion of monomers versus time to large oligomers in PED-3h. Dashed lines in (b) are guides for the eye.

FIG. 6 shows the structural characterization of TPEUs: (a)¹H-NMR spectrum of PU1.1 and (b) FTIR spectrum of PU2.1 at 24 hours.

FIG. 7 shows FTIR spectra of the carbonyl region of (a1-3) PU1.1, PU1.7 and PU2.1, respectively, and (b1-3) PU2.1 at 2, 4 and 18 h, respectively. The C═O stretching bands are baseline corrected. The dashed curves are the component peaks obtained by deconvolution into Gaussians.

FIG. 8 shows hydrogen bonding index, R() and associated degree of phase separation (∘) and the relative area of free carbonyl groups (▴) in TPEUs with varying (a) NCO:OH ratio and (b) polymerization time. Lines in (a) and (b) are guides for the eye.

FIG. 9 shows DSC melting data obtained from the second heating cycle for TPEUs with different (1) NCO:OH ratios and (2) polymerization times. (a and d): melting curves (b and e): temperatures of melting and (c and f): enthalpies of melting. The dashed lines are fits of the data to linear functions (R²>0.9223) in (b) and (c); and to a sigmoidal (R²=0.9906) and exponential decay functions (R²=0.9369) in (e) and (f), respectively.

FIG. 10 shows derivative TGA (DTG) curves for PED and TPEUs with varying NCO:OH ratio.

FIG. 11 shows stress-strain curves measured at room temperature for (a) PU1.1, PU1.7 and PU2.1 and (b) PU2.1 samples extracted at selected polymerization times. Polymerization time is reported on the curves in (b).

FIG. 12 shows (a) Young's modulus, (b) tensile strength and (c) maximum strain of TPEUs at various polymerization times. The dashed lines are guides for the eye.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### DEFINITIONS

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “reaction” and “reacting” refer to the conversion of a substance into a product, irrespective of reagents or mechanisms involved.

As used herein, “polymer” refers to a substance having a chemical structure that includes the multiple repetition of constitutional units formed from substances of comparatively low relative molecular mass relative to the molecular mass of the polymer. The term “polymer” includes soluble and/or fusible molecules having chains of repeat units, and also includes insoluble and infusible networks.

As used herein, “monomer” refers to a substance that can undergo a polymerization reaction to contribute constitutional units to the chemical structure of a polymer.

As used herein, “polyurethane” refers to a polymer comprising two or more urethane (or carbamate) linkages. Other types of linkages can be included, however. For example, in some instances, the polyurethane or polycarbamate can contain urea linkages, formed, for example, when two isocyanate groups can react. In some other instances, a urea or urethane group can further react to form further groups, including, but not limited to, an allophanate group, a biuret group, or a cyclic isocyanurate group. In some embodiments, at least 70%, or at least 80%, or at least 90%, or at least 95% of the linkages in the polyurethane or polycarbamate are urethane linkages. Such “polyurethanes” can include polyurethane block copolymers, which refers to a block copolymer, where one or more of the blocks are a polyurethane or a polycarbamate. Other blocks in the “polyurethane block copolymer” may contain few, if any, urethane linkages. For example, in some polyurethane block copolymers, at least one of the blocks is a polyether or a polyester and one or more other blocks are polyurethanes or polycarbamates.

As used herein, “polyester” refers to a polymer comprising two or more ester linkages. Other types of linkages can be included, however. In some embodiments, at least 80%, or at least 90%, or at least 95% of the linkages in the polyester are ester linkages. The term can refer to an entire polymer molecule, or can also refer to a particular polymer sequence, such as a block within a block copolymer. The term “dihydroxyl polyester” refers to a polyester having two or more free hydroxyl groups, e.g., at the terminal (e.g., reacting) ends of the polymer (i.e., a “dihydroxyl-terminated polyester”). In some embodiments, such polyesters have exactly two free hydroxyl groups.

As used herein, “alcohol” or “alcohols” refer to compounds having the general formula: R—OH, wherein R denotes any organic moiety (such as alkyl, aryl, or silyl groups), including those bearing heteroatom-containing substituent groups. In certain embodiments, R denotes alkyl, alkenyl, aryl, or alcohol groups. In certain embodiments, the term “alcohol” or “alcohols” may refer to a group of compounds with the general formula described above, wherein the compounds have different carbon lengths. The term “hydroxyl” refers to a —OH moiety. In some cases, an alcohol can have more than two or more hydroxyl groups. As used herein, “diol” and “polyol” refer to alcohols having two or more hydroxyl groups.

As used herein, “isocyanate” or “isocyanates” refer to compounds having the general formula: R—NCO, wherein R denotes any organic moiety (such as alkyl, aryl, or silyl groups), including those bearing heteroatom-containing substituent groups. In certain embodiments, R denotes alkyl, alkenyl, aryl, or alcohol groups. In certain embodiments, the term “isocyanate” or “isocyanates” may refer to a group of compounds with the general formula described above, wherein the compounds have different carbon lengths. The term “isocyanato” refers to a —NCO moiety. In some cases, an isocyanate can have more than two or more isocyanato groups. As used herein, “diisocyanate” and “polyisocyanate” refer to isocyanates having two or more isocyanato groups.

As used herein, “carboxylic acid” or “carboxylic acids” refer to compounds having the general formula: R—CO₂H, wherein R denotes any organic moiety (such as alkyl, aryl, or silyl groups), including those bearing heteroatom-containing substituent groups. In certain embodiments, R denotes alkyl, alkenyl, aryl, or alcohol groups. In certain embodiments, the term “carboxylic acid” or “carboxylic acids” may refer to a group of compounds with the general formula described above, wherein the compounds have different carbon lengths. The term “carboxyl” refers to a —CO₂H moiety. In some cases, an isocyanate can have more than two or more carboxy groups. As used herein, “dicarboxylic acid” and “polycarboxylic acid” refer to carboxylic acids having two or more carboxyl groups.

The terms “group” or “moiety” refers to a linked collection of atoms or a single atom within a molecular entity, where a molecular entity is any constitutionally or isotopically distinct atom, molecule, ion, ion pair, radical, radical ion, complex, conformer etc., identifiable as a separately distinguishable entity.

As used herein, “mix” or “mixed” or “mixture” refers broadly to any combining of two or more compositions. The two or more compositions need not have the same physical state; thus, solids can be “mixed” with liquids, e.g., to form a slurry, suspension, or solution. Further, these terms do not require any degree of homogeneity or uniformity of composition. This, such “mixtures” can be homogeneous or heterogeneous, or can be uniform or non-uniform. Further, the terms do not require the use of any particular equipment to carry out the mixing, such as an industrial mixer.

As used herein, the term “natural oil” or “lipid” refers to oils derived from various plants or animal sources. These terms include natural oil derivatives, unless otherwise indicated. The terms also include modified plant or animal sources (e.g., genetically modified plant or animal sources), unless indicated otherwise. Examples of natural oils include, but are not limited to, vegetable oils, algae oils, fish oils, animal fats, tall oils, derivatives of these oils, combinations of any of these oils, and the like. Representative non-limiting examples of vegetable oils include rapeseed oil (canola oil), coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, and castor oil. Representative non-limiting examples of animal fats include lard, tallow, poultry fat, yellow grease, and fish oil. Tall oils are by-products of wood pulp manufacture. In some embodiments, the natural oil or natural oil feedstock comprises one or more unsaturated glycerides (e.g., unsaturated triglycerides).

As used herein, “natural oil derivatives” refers to the compounds or mixtures of compounds derived from a natural oil using any one or combination of methods known in the art. Such methods include but are not limited to saponification, fat splitting, transesterification, esterification, hydrogenation (partial, selective, or full), isomerization, oxidation, and reduction. Representative non-limiting examples of natural oil derivatives include gums, phospholipids, soapstock, acidulated soapstock, distillate or distillate sludge, fatty acids and fatty acid alkyl ester (e.g. non-limiting examples such as 2-ethylhexyl ester), hydroxy substituted variations thereof of the natural oil. For example, the natural oil derivative may be a fatty acid methyl ester (“FAME”) derived from the glyceride of the natural oil.

As used herein, “alkyl” refers to a straight or branched chain saturated hydrocarbon having 1 to 30 carbon atoms, which may be optionally substituted, as herein further described, with multiple degrees of substitution being allowed. Examples of “alkyl,” as used herein, include, but are not limited to, methyl, ethyl, n-propyl, isopropyl, isobutyl, n-butyl, sec-butyl, tert-butyl, isopentyl, n-pentyl, neopentyl, n-hexyl, and 2-ethylhexyl.

For any compound, group, or moiety, the number carbon atoms in that compound, group, or moiety is represented by the phrase “C_{x-y}” which refers to an such a compound, group, or moiety, as defined, containing from x to y, inclusive, carbon atoms. Thus, “C₁₋₆alkyl” refers to an alkyl chain having from 1 to 6 carbon atoms.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A1 and A2, then one or more members of the class can be present concurrently.

As used herein, the various functional groups represented will be understood to have a point of attachment at the functional group having the hyphen or dash (-) or an asterisk (*). In other words, in the case of —CH₂CH₂CH₃, it will be understood that the point of attachment is the CH₂ group at the far left. If a group is recited without an asterisk or a dash, then the attachment point is indicated by the plain and ordinary meaning of the recited group.

In some instances herein, organic compounds are described using the “line structure” methodology, where chemical bonds are indicated by a line, where the carbon atoms are not expressly labeled, and where the hydrogen atoms covalently bound to carbon (or the C—H bonds) are not shown at all. For example, by that convention, the formula

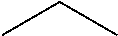

represents n-propane.

As used herein, multi-atom bivalent species are to be read from left to right. For example, if the specification or claims recite A-D-E and D is defined as —OC(O)—, the resulting group with D replaced is: A-OC(O)—E and not A-C(O)O-E.

Unless a chemical structure expressly describes a carbon atom as having a particular stereochemical configuration, the structure is intended to cover compounds where such a stereocenter has an R or an S configuration.

Other terms are defined in other portions of this description, even though not included in this subsection.

### TPEU Compositions

In at least one aspect, the disclosure provides polymer compositions, comprising one or more polymers having constitutional units according to formula (I):

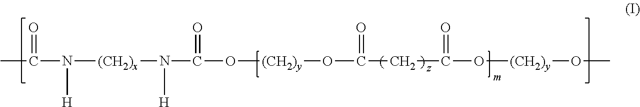

wherein: x is an integer from 2 to 40; y is an integer from 9 to 22; z is an integer from 7 to 22; and m is an integer from 2 to 50; wherein the one or more polymers in the composition have a weight-average molecular weight (M_{w}) of at least 44,000 g/mol.

The variable x can have any suitable value, depending on the diisocyanate used to make the polymer. For example, in some embodiments, x is an integer from 2 to 30, or from 3 to 20, or from 4 to 15, or from 5 to 10, or from 6 to 8. In some embodiments, x is 7. The segment containing x and including the carbamate linkages can be referred to as the “urethane segment” of the polymer.

In some embodiments of any of the aforementioned embodiments, the urethane segment can be formed from a lipid-derived monomer, such as lipid-derived 1,7-heptamethylene diisocyanate. In some such embodiments, the urethane segments in the polymer have a renewable carbon content of at least 85%, or at least 90%, or at least 95%. In some embodiments, the urethane segments in the polymer have a renewable carbon content of 100%.

The variable y can have any suitable value, depending on the diol used to make the polyester portion (i.e., the portion within the “m” bracket, which is referred to herein as the “polyester segment”). In some embodiments of any of the aforementioned embodiments, y is an integer from 9 to 20, or from 9 to 18, or from 9 to 16, or from 9 to 14, or from 9 to 12. In some such embodiments, y is 9. In an analogous manner, the variable z can have any suitable value, depending on the dicarboxylic acid (or esters thereof, such as a C₁₋₆ alkyl ester, i.e., methyl). In some embodiments of any of the aforementioned embodiments, z is an integer from 7 to 20, or from 7 to 18, or from 7 to 16, or from 7 to 14, or from 7 to 12, or from 7 to 10. In some such embodiments, z is 7.

In some embodiments of any of the aforementioned embodiments, the polyester segment can be formed from a lipid-derived monomers, such as lipid-derived 1,9 nonanediol and lipid-derived azelaic acid (or esters thereof, such as a C₁₋₆ alkyl ester, i.e., methyl). In some such embodiments, the polyester segments in the polymer have a renewable carbon content of at least 85%, or at least 90%, or at least 95%. In some embodiments, the polyester segments in the polymer have a renewable carbon content of 100%.

The variable m can have any suitable value depending on the molecular weight of the constituent polyesters. In some embodiments, the polyester segments have a number-average molecular weight (Mₙ) of at least 3500 g/mol, or at least 4000 g/mol, or at least 4500 g/mol, and, in some embodiments, up to 6000 g/mol. Thus, in some embodiments, m is an integer from 2 to 25, or from 3 to 20, or from 4 to 15, or from 5 to 10.

The resulting TPEU polymers that make up the composition generally have a high molecular weight. In some embodiments, the one or more polymers in the composition have a weight-average molecular weight (M_{w}) of at least 60,000 g/mol, or at least 80,000 g/mol, or at least 100,000 g/mol, or at least 200,000 g/mol, or at least 300,000 g/mol, or at least 400,000 g/mol, or at least 500,000 g/mol, or at least 600,000 g/mol.

In some embodiments, the one or more TPEU polymers in the composition have dominant van der Waals forces, leading to certain desirable physical properties. In some embodiments, the intermolecular hydrogen bonding forces in the one or more polymers are diluted by dominant van der Waals forces.

The one or more TPEU polymers can make up any suitable proportion of the polymer composition. In some embodiments, the one or more TPEU polymers make up at least 80% by weight, or at least 85% by weight, or at least 90% by weight, or at least 95% by weight, or at least 97% by weight, or at least 99% by weight, of the polymer composition, based on the total weight of polymeric solids in the polymer composition.

The resulting polymer composition can have any suitable physical properties. In some embodiments, the polymer composition exhibits one or more of the following properties: an initial modulus ranging from 115 MPa to 533 MPa; an ultimate tensile strength ranging from 8.6 MPa to 20.1 MPa; or an ultimate elongation at break ranging from 5.2% to 404%. In some embodiments, the polymer composition exhibits one or more of the following properties: an onset temperature of thermal decomposition at 5% weight loss ranging from 265° C. to 271° C.; a peak decomposition temperature ranging from 293° C. to 301° C. for the urethane segments; a peak decomposition temperature ranging from 400° C. to 405° C. for the polyester segments; or a pyrolysis temperature ranging from 450° C. to 456° C. In some embodiments, the polymer composition exhibits one or more of the following properties: an onset of melting temperature ranging from 14.6° C. to 31.5° C.; an offset temperature ranging from 57.9° C. to 63.3° C.; a peak melting temperature ranging from 44.9° C. to 50.6° C.; or a glass transition temperature ranging from −43° C. to −35° C. In some embodiments, the polymer composition has an enthalpy of melting ranging from 50 J/g to 57.7 J/g. In some embodiments, the polymer composition reaches its tensile half-life in no more than one day upon immersion in water at 80° C.

The constitutional units of formula (I) can make up any suitable amount of the one or more TPEU polymers in the composition. In some embodiments, the constitutional units of formula (I) make up at least 80% by weight, or at least 90% by weight, or at least 95% by weight, or at least 97% by weight, or at least 98% by weight, or at least 99% by weight of the one or more polymers.

In some embodiments of any of the aforementioned embodiments, the polymer composition can have certain desirable degradation characteristics. Thus, in some embodiments, upon immersing the one or more polymers in water at 80° C. for 30 days, the one or more polymers degrade into one or more hydrolyzed products, the one or more hydrolyzed products having a weight-average molecular weight (M_{w}) of no more than 4000 g/mol. In some embodiments, the polymer composition exhibits one or more of the following properties: an increased enthalpy of melting ranging from 26.3 J/g to 77.4 J/g following immersion of the polymer composition in water for 5 days at 80° C.; or a decreased enthalpy of about 28 J/g following immersion of the polymer composition in water for 20 days at 80° C. In some embodiments, the polymer composition undergoes tensile failure in no more than 10 days of immersion in water at 80° C. In some embodiments, the polymer composition reaches its tensile half-life in no more than one day upon immersion in water at 80° C.

In other aspects, the disclosure provides polymer compositions, comprising one or more urethane polymers formed from a first reaction mixture, which comprises C₂₋₄₀ diisocyanates and dihydroxyl-terminated polyesters; wherein the dihydroxyl-terminated polyesters are formed from a second reaction mixture, which comprises C₉₋₂₂ diols and C₇₋₂₂ dicarboxylic acids or esters thereof; and wherein the dihydroxyl-terminated polyesters in the first reaction mixture have a number-average molecular weight (Mₙ) of at least 3000 g/mol.

The denotation of the “first” and “second” reaction mixture does not imply any ordering of steps, but merely distinguishes the two reaction mixtures from each other.

Any suitable C₂₋₄₀ diisocyanates can be used. In some embodiments, the C₂₋₄₀ diisocyanates are C₂₋₃₀ diisocyanates, or C₃₋₂₀ diisocyanates, or C₄₋₁₅ diisocyanates, or C₅₋₁₀ diisocyanates, or C₆₋₈ diisocyanates. In some such embodiments, the C₂₋₄₀ diisocyanates are 1,7-heptamethylene diisocyanate.

In some embodiments of any of the aforementioned embodiments, the urethane segment can be formed from a lipid-derived monomer, such as lipid-derived 1,7-heptamethylene diisocyanate. In some such embodiments, the urethane segments in the polymer have a renewable carbon content of at least 85%, or at least 90%, or at least 95%. In some embodiments, the urethane segments in the polymer have a renewable carbon content of 100%.

Any suitable C₉₋₂₂ diols can be used. In some embodiments, the C₉₋₂₂ diols are C₉₋₂₀ diols, or C₉₋₁₈ diols, or C₉₋₁₆ diols, or C₉₋₁₄ diols, or C₉₋₁₂ diols. In some embodiments, the C₉₋₂₂ diols are 1,9-nonanediol. Further, any suitable C₇₋₂₂ dicarboxylic acids (or esters thereof, such as a C₁₋₆ alkyl ester, i.e., methyl). In some embodiments, the C₇₋₂₂ dicarboxylic acids or esters thereof are C₇₋₂₀ dicarboxylic acids, or C₇₋₁₈ dicarboxylic acids, C₇₋₁₆ dicarboxylic acids, or esters of thereof. In some embodiments, the C₇₋₂₂ dicarboxylic acids or esters thereof are azelaic acid or esters thereof.

In some embodiments of any of the aforementioned embodiments, the dihydroxyl-terminated polyesters can be formed from lipid-derived monomers, such as lipid-derived 1,9-nonanediol and lipid-derived azelaic acid (or esters thereof, such as a C₁₋₆ alkyl ester, i.e., methyl). In some such embodiments, the polyester segments in the polymer have a renewable carbon content of at least 85%, or at least 90%, or at least 95%. In some embodiments, the polyester segments in the polymer have a renewable carbon content of 100%.

In some embodiments, the dihydroxyl-terminated polyesters have a number-average molecular weight (Mₙ) of at least 3500 g/mol, or at least 4000 g/mol, or at least 4500 g/mol, and, in some embodiments, up to 6000 g/mol.

In some embodiments, the dihydroxyl-terminated polyesters can have any suitable physical properties. In some embodiments, the dihydroxyl-terminated polyesters in the first reaction mixture have a polydispersity index ranging from 1 to 2. In some embodiments, the dihydroxyl-terminated polyesters in the first reaction mixture exhibit one or more of the following properties: an onset temperature of thermal decomposition at 5% weight loss of about 214° C.; a peak decomposition temperature of about 412° C.; or a pyrolysis temperature of about 457° C. In some such embodiments, “about” means±3° C.

The resulting urethane polymers that make up the composition generally have a high molecular weight. In some embodiments, the one or more polymers in the composition have a weight-average molecular weight (M_{w}) of at least 44,000 g/mol, or at least 60,000 g/mol, or at least 80,000 g/mol, or at least 100,000 g/mol, or at least 200,000 g/mol, or at least 300,000 g/mol, or at least 400,000 g/mol, or at least 500,000 g/mol, or at least 600,000 g/mol.

In some embodiments, the one or more urethane polymers in the composition have dominant van der Waals forces, leading to certain desirable physical properties. In some embodiments, the intermolecular hydrogen bonding forces in the one or more polymers are diluted by dominant van der Waals forces.

The resulting polymer composition can have any suitable physical properties. In some embodiments, the polymer composition exhibits one or more of the following properties: an initial modulus ranging from 115 MPa to 533 MPa; an ultimate tensile strength ranging from 8.6 MPa to 20.1 MPa; or an ultimate elongation at break ranging from 5.2% to 404%. In some embodiments, the polymer composition exhibits one or more of the following properties: an onset temperature of thermal decomposition at 5% weight loss ranging from 265° C. to 271° C.; a peak decomposition temperature ranging from 293° C. to 301° C. for the urethane segments; a peak decomposition temperature ranging from 400° C. to 405° C. for the polyester segments; or a pyrolysis temperature ranging from 450° C. to 456° C. In some embodiments, the polymer composition exhibits one or more of the following properties: an onset of melting temperature ranging from 14.6° C. to 31.5° C.; an offset temperature ranging from 57.9° C. to 63.3° C.; a peak melting temperature ranging from 44.9° C. to 50.6° C.; or a glass transition temperature ranging from −43° C. to −35° C. In some embodiments, the polymer composition has an enthalpy of melting ranging from 50 J/g to 57.7 J/g.

The one or more urethane polymers can make up any suitable proportion of the polymer composition. In some embodiments, the one or more urethane polymers make up at least 80% by weight, or at least 85% by weight, or at least 90% by weight, or at least 95% by weight, or at least 97% by weight, or at least 99% by weight, of the polymer composition, based on the total weight of polymeric solids in the polymer composition.

In some embodiments of any of the aforementioned embodiments, the polymer composition can have certain desirable degradation characteristics. Thus, in some embodiments, upon immersing the one or more polymers in water at 80° C. for 30 days, the one or more polymers degrade into one or more hydrolyzed products, the one or more hydrolyzed products having a weight-average molecular weight (M_{w}) of no more than 4000 g/mol. In some embodiments, the polymer composition exhibits one or more of the following properties: an increased enthalpy of melting ranging from 26.3 J/g to 77.4 J/g following immersion of the polymer composition in water for 5 days at 80° C.; or a decreased enthalpy of about 28 J/g following immersion of the polymer composition in water for 20 days at 80° C. In some embodiments, the polymer composition undergoes tensile failure in no more than 10 days of immersion in water at 80° C. In some embodiments, the polymer composition reaches its tensile half-life in no more than one day upon immersion in water at 80° C.

The TPEUs disclosed herein can be synthesized by any suitable means, although some means may be more desirable than others. Suitable synthetic methodologies are disclosed in the Examples, below. The claims to the compounds, or to compositions including the compounds, are not limited in any way by the synthetic method used to make the compounds.

### Examples

The following examples are provided to illustrate one or more preferred embodiments of the invention. Numerous variations can be made to the following examples that lie within the scope of the claimed inventions.

### Experimental

### Materials

Nonanedioic acid (azelaic acid, 85%), 1,9-nonanediol (ND, 98%), titanium (IV) butoxide (98%), stannous octoate (Sn(Oct)₂) (98%), dibutylamine (98%), anhydrous tetrahydrofuran (THF), calcium hydride (98%), diethyl ether, chloroform (CHCl₃, 99.8%), chloroform (HPLC grade) and methanol (99.8%) were purchased from Sigma Aldrich (Oakville, ON), Canada. All reagents except azelaic acid, DMF and THF were used as obtained. Azelaic acid was recrystallized from distilled water to a purity of 97% before use. DMF was dried overnight over calcium hydride followed by vacuum distillation (˜300 Torr). THF was distilled after drying overnight over 4 A molecular sieves. HPMDI was synthesized according to the method disclosed in Hojabri et al., Biomacromolecules, vol. 10, pp. 884-891 (2009).

### Synthesis and Purification of Polyester Diols

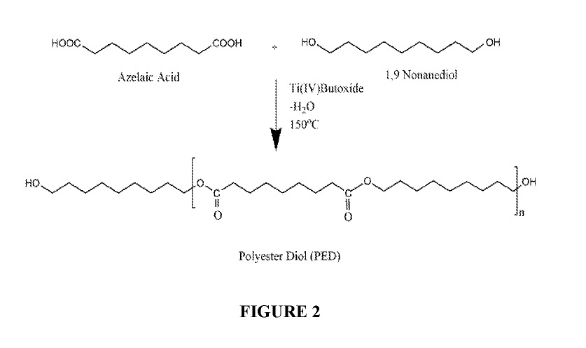

The PED, dihydroxy poly(nonanenonanoate), was synthesized by melt-condensation of oleic acid-derived azelaic acid and 1,9 nonanediol (ND) in the presence of titanium (IV) butoxide as catalyst. The scheme is shown in FIG. 2. Azelaic acid, excess ND and titanium (IV) butoxide were added in bulk to a three necked 250 mL flask connected to a condenser, thermometer and vacuum outlet. The esterification reactions were carried out at 150° C. under constant stirring at 550 rpm. The excess ND relative to azelaic acid provided an initial molar diacid to diol stoichiometric imbalance, r, smaller than unity. The starting PED was synthesized with an initial azelaic acid:ND imbalance of r=0.8. This value was chosen based on the results obtained with four different values of initial stoichiometric imbalance (r=0.9, 0.08, 0.7 and 0.6). This preliminary work also involved the optimization of the reaction time for molecular weight and PDI. The results of this optimization are provided in the Supporting Information. The PED synthesized with r=0.8 and without further induced stoichiometric imbalance is referred to herein as PED0.8.

Following the initial stoichiometric imbalance, the polyesterification reaction was arrested at a selected time (t_{E}) by inducing a secondary stoichiometric imbalance by adding an extra controlled amount of ND (diacid:ND=0.1). The induced stoichiometric imbalance was fixed at r=0.1 to achieve a r value between 0.8 and 0.7 at the arresting reaction time. Molecular weight development was monitored by GPC. Four reactions were conducted with 16 mmol (3.06 g) of azelaic acid and 20 mmol (3.27 g) of ND in the presence of 0.032 mmol (0.011 g) of catalyst. A fixed amount of extra diol, 4 mmol (0.64 g) and catalyst (0.0022 g) was added in each reaction at =1, 3, 5 or 7 hours, shown in Table 1 below. An inert atmosphere (N₂ gas) was supplied for an hour after the initial stoichiometric imbalance and for the hour following the induced stoichiometric imbalance. Vacuum (300 Torr) was applied when the N₂ supply was discontinued. The reaction was terminated four hours after by cooling the system to room temperature.

Molecular weight and PDI of the PEDs were measured every hour with gel permeation chromatography (GPC). The structure of PEDs was confirmed by proton nuclear magnetic resonance spectroscopy (¹H-NMR). The crude PEDs (6 g) were dissolved in 30 mL of chloroform and precipitated in methanol. The low molecular weight alcohols remained in solution while larger diols precipitated out. The optimum ratio of chloroform to methanol was determined by systematically varying the ratios of the PED solution in CHCl₃ with excess methanol until all impurities were consistently removed in a single step and PEDs achieved a target PDI of less than 2. The larger diols with molecular weights close to the target were procured by purification of PEDs with methanol: chloroform ratio of 15:1 (v/v).

For ease of presentation and discussion, the PEDs are coded based on the time of induced stoichiometric imbalance as shown in Table 1. PED-1h (3h, 5h or 7h) represents the PED produced when the stoichiometric imbalance was induced at 1 h (3 h, 5 h or 7 h).

TABLE 1

| PEDs | t_{E} (h) | tₜₒₜₐₗ (h) |
|---|---|---|
| PED-1 h | 1 | 5 |
| PED-3 h | 3 | 7 |
| PED-5 h | 5 | 9 |
| PED-7 h | 7 | 11 |

Synthesis of Thermoplastic Poly(ester urethane) Elastomers

Effect of NCO:OH Ratio

PED-3h was selected for polymerization because it showed a molecular weight closest to the industry standard for TPEU synthesis of 2000 g/mol (1850 g/mol by ¹H-NMR) and was produced with the highest yield (77%). The molecular weight of PED-3h is also comparable to that of the monomer polyethylene adipate diol (PEAD, DESMOPHEN 2000).

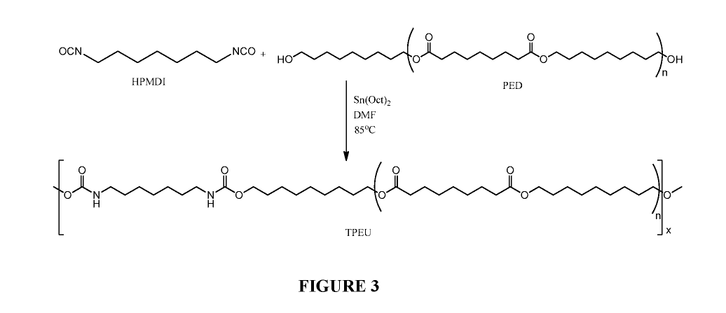

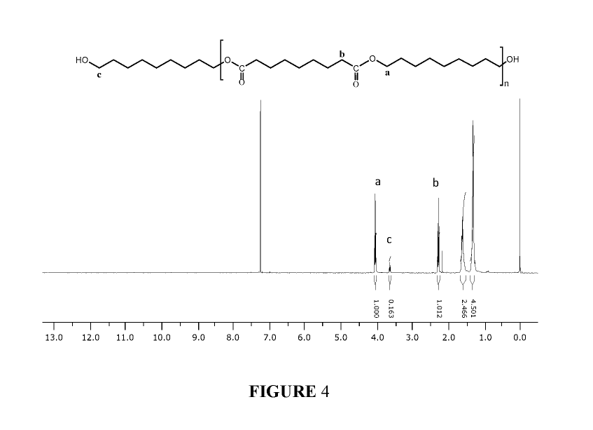

The TPEUs were prepared by reacting PED-3h, in the presence of Sn(Oct)₂ catalyst and HPMDI in a single step, so called the one-shot polymerization method, which is illustrated in FIG. 3. HPMDI was dissolved in anhydrous DMF under a N₂ atmosphere in a three necked flask and stirred. The PED and catalyst (20 mg/5 mL) were dissolved in anhydrous DMF and were added to the HPMDI via an addition funnel. The reaction was stirred at 85° C. and 400 rpm. The NCO:OH ratio was increased from 1.1 in five steps (1.2, 1.3, 1.6, and 1.7 and 2.1) until TPEUs showed no residual diol content.

The products were analyzed by ¹H-NMR and Fourier transform infrared spectroscopy (FTIR) to determine NCO content and detect residual diol. The TPEUs with NCO:OH ratios of 1.1, 1.7 and 2.1 and complete polymerization (24 hours), representing the entire range, were characterized by ¹H-NMR, FTIR, GPC, thermogravimetric analysis (TGA), differential scanning calorimetry (DSC) and tensile tests to determine the effect of NCO:OH ratio on the physical properties of the TPEU.

Also for ease of presentation and discussion, the TPEUs of this experiment are coded based on their NCO:OH ratio value; PU2.1, PU1.7 and PU1.1 represent the reaction and the TPEU prepared with an NCO:OH ratio of 2.1:1, 1.7:1 and 1:1, respectively.

Effect of Polymerization Time

The effect of polymerization time (t) on the molecular weight of TPEU was investigated for the reaction in which NCO:OH ratio was fixed at 2.1:1. PU2.1 samples were extracted from the reaction mixture at 2, 4, 6, 18 and 24 hours. Up to 5 hours, the reaction mixture was liquid and samples were easily extracted. At 6, 18 and 24 hours, the reaction mixture became increasingly gel-like. The liquid samples dissolved easily in CHCl₃; whereas, the gel-like samples remained insoluble and could not be analyzed by GPC. The samples were soaked in excess water and dried under vacuum. All the dry samples were insoluble in chloroform. Samples were purified by soaking in chloroform (10 mL/g) for one hour followed by washing with excess methanol and dried under vacuum. All purified samples were insoluble in chloroform, THF and DMF.

The TPEUs of this experiment are distinguished by the time (in hours, h) at which they were extracted; namely PU2.1 at 2 h, 3 h, 4 h, 5 h, 6 h, 18 h and 24 h. The structure of the TPEUs was examined by ¹H-NMR and FTIR, and their thermal transition, thermal degradation and mechanical properties were determined by DSC, TGA and tensile testing, respectively.

### Characterization Techniques

Gas Phase Chromatography

Gas phase chromatography (GPC) was used to determine the number average molecular weight (Mₙ), weight-average molecular weight (M_{w}) and polydispersity index (PDI=M_{w}/Mₙ). GPC tests were carried out on a Waters Alliance e2695 separation module (Milford, Mass., USA), equipped with a Waters 2414 refractive index detector and a high resolution Styragel HRSE column (5 μm). Chloroform was used as the eluent with a flow rate of 0.5 mL/min. Detector and column temperatures were 40° C. and 43° C., respectively. The concentration of the sample was 1 mg/mL and the injection volume was 30 μL. Polystyrene standards (molecular weight range between 1.2×103 and 133×103 Da) were used to calibrate the curves.

¹H NMR

¹H-NMR spectra were recorded on a Bruker Advance III 400 spectrometer (BrukerBioSpin MRI GmbH, Karlsruhe, Germany) at a frequency of 400 MHz using a 5-mm BBO probe. The spectra were acquired at 25° C. over a 16-ppm window with a 1-s recycle delay, 32 transients. Spectra were Fourier transformed, phase corrected, and baseline corrected. Chemical shifts were referenced relative to the residual solvent peak (CDCl₃, δ(1H)=7.26 ppm).

TGA

TGA was carried out on a Q500 TGA model (TA instrument, Newcastle, Del., USA), under dry nitrogen of 40 mL/min (balance purge flow) and 60 mL/min (sample purge flow). Approximately 9.0-10.0 mg of sample was loaded in an open TGA platinum pan, equilibrated at 25° C. and then heated to 600° C. at 10° C./min.

FTIR

FTIR was performed on a Thermo Scientific Nicolet 380 FTIR spectrometer (Thermo Electron Scientific Instruments, LLC, USA) equipped with a PIKE MIRacle attenuated total reflectance (ATR) system (PIKE Technologies, Madison, Wis., USA.). The sample was placed onto the ATR crystal area and held in place by a pressure arm. The spectrum was acquired in the scanning range of 400-4000 cm-1 using 64 scans at a resolution of 4 wavenumbers. All spectra were recorded at ambient temperature.

FTIR was used to determine the changes in hydrogen bonding in the TPEUs. The carbonyl hydrogen bonding index (R), which indicates the extent of participation of the carbonyl group in hydrogen bonding, was calculated from the relative intensities of the normalized hydrogen-bonded and the free carbonyl stretching peaks. R provides a measure of the degree of phase separation (DPS). The measure of conversion of hydrogen bonded carbonyl groups to the free hydrogen bonded carbonyl state was calculated as the ratio of the area under the curve associated with the free carbonyl peaks to the total area A_{fr}=(area_{Frec}/area_{Total}). The peak modeling of the carbonyl bands region (1780 cm⁻¹ to 1660 cm⁻¹) was carried out using the Gaussian curve-fitting module of OriginPro software (version 9.2, 2015) after baseline correction.

Tensile Testing

Films for tensile testing were prepared on a Carver 12-ton hydraulic heated bench press (Model 3851-0—Wabash, Ind., USA). The dry samples were melt pressed at 150° C. and cooled at a controlled rate of 5° C./min. The mechanical properties of the TPEU films were measured at room temperature (RT=23° C.) by uniaxial tensile testing using a texture analyzer (Texture Technologies Corp, NJ, USA) equipped with a 2-kg load cell following the ASTM D882 procedure. The sample was stretched at 5 mm/min from a gauge of 35 mm. The reported results are the average of at least four specimens.

DSC

DSC measurements were carried out on a Q200 model DSC (TA instrument, Newcastle, Del., USA) under a dry nitrogen gas atmosphere following the ASTM D3418 standard. The PED sample (5.0-6.0 mg±0.3 mg), contained in a hermetically sealed aluminum pan, was first heated to 110° C. at 10° C./min (1st heating cycle), held at that temperature for 5 min to erase thermal history and then cooled to −50° C. at 5° C./min. The sample was subsequently heated to 120° C. at 3° C./min (2nd heating cycle). The TPEU sample (5.0-6.0 mg±0.6 mg), also contained in a hermetically sealed aluminum pan, was heated to 180° C. at 10° C./min during the 1st heating cycle and held at that temperature for 5 min to erase thermal history, then cooled to −80° C. at 5° C./min. The sample was subsequently heated to 180° C. at 10° C./min for a 2nd heating cycle. The second heating cycles were performed in the DSC modulated mode with a modulation amplitude of 1° C./min and a period of 60 s.

Solubility Tests

Solubility tests were conducted on the dry purified TPEU samples in CHCl₃, THF and DMF, which are common organic solvents for processing polyurethanes. The sample (1 mg of TPEU in 1 mL of solvent) was stirred for 30 minutes and left in the solvent for 2 days. The sample was then brought to the boiling point of the solvent repeatedly. In DMF, samples were refluxed for 15 minutes.

### Results and Discussion

### Structural Characterization of PEDs

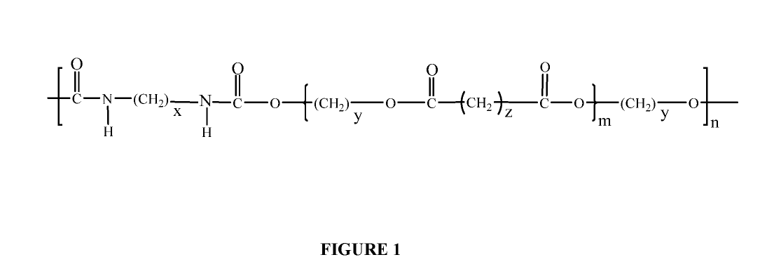

Polyester diols were successfully synthesized by induced stoichiometric imbalance at selected reaction times and characterized by ¹H-NMR. See U.S. patent application Ser. No. 14/854,840, filed Sep. 15, 2015, which is incorporated herein by reference. The spectrum of PED-3h typical of all the PEDs synthesized in this work is shown in FIG. 4. Chemical shifts characteristic of methylene groups adjacent to the oxygen and carbonyl in the ester groups (CH₂O, 4.06 ppm and CH₂C=0, 2.29 ppm, a and b in FIG. 1) and hydroxyl groups (CH₂OH, 3.65 ppm, c in FIG. 1) confirm the formation of the polyester linkage. The absence of the chemical shift near 11 ppm and at 2.33 ppm characteristic of the carboxylic group proton and the methylene protons adjacent to the carbonyl carbon of the carboxylic acid group, respectively, indicate that the sample was acid-free.

### Molecular Weight Control of PEDs

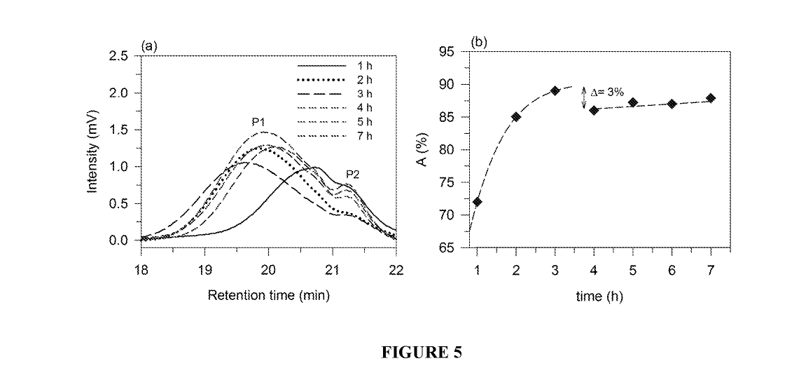

FIG. 5a shows the GPC curves for PED-3h at different reaction times, typical of all PEDs prepared by induced stoichiometric imbalance. The number average molecular weight (Mₙ) and PDI obtained by GPC for the PEDs prepared by induced stoichiometric imbalance before and after the addition of the extra diol are listed in Table 5. The multimodal GPC curves are indicative of heterogeneous polymerization. They are constituted of a leading peak (P1 in FIG. 5a) associated with the largest molecular size species followed by a group of peaks (P2 in FIG. 5a) associated with the smaller oligomers (including cyclic oligomers) and unreacted monomers. One can notice that until (3 h in FIG. 5a), P1 shifted continuously to shorter elution times indicating a steady increase in molecular weight. An hour after the induced stoichiometric imbalance, P1 shifted back to a higher elution time indicating a drop of molecular weight to its equilibrium value.

The relative areas under P1 and P2 are directly proportional to the conversion of the monomers into large species and small oligomers/monomers, respectively. FIG. 5b presents the evolution of the relative conversion (A %) for PED-3h calculated as the ratio of the area under P1 and the total area under the GPC curve. The drop in conversion showing after 3 hours in FIG. 5b was also observed after t_{E} in all the induced stoichiometric imbalance experiments and is explained by the decline in the actual stoichiometric imbalance caused by the introduction of the extra diol. The drop in conversion was minimum for PED-3h (Δ=3% in FIG. 5b) and then increased with increasing t_{E} (5% for t_{E}=5 h, and 13% for t_{E}=7 h). No decline in conversion was observed for PED-1h. This is attributed to the fact that at lower conversions, when stoichiometric imbalance is induced, the presence of active sites still available for polymerization in monomers, carboxyl/hydroxyl or dicarboxyl terminated dimers and small oligomers offset the decline in conversion.

The conversion data are confirmed by the Mₙ data. As shown in Table 2 (below), except for PED-1h, Mₙ of all other PEDs declined at t_{E}+1, commensurate with the decline in their conversion. The Mₙ of all the PEDs increased at the end of the polymerization (t_{Total} in Table 2), a sign that the extra diol had reacted with residual acid-capped oligomers. The large decline in conversion (13%) of PED-7h at t_{E} and its small Mₙ recovery at t_{Total} (Table 2) is attributed to two factors related to its prolonged polymerization viz, (i) the remaining of limited active sites on the formed PEDs post induced stoichiometric imbalance and (ii) maximum effect of intermolecular interchange reaction or transesterification of the larger species by the hydroxyl terminated ND, causing a breakdown of polyester chains to smaller molecules. It is of note that PED-3h and PED-5h showed molecular weights at t_{Total} close to those obtained at t_{E} indicating that induced stoichiometric imbalance at 3 hours and 5 hours was effective in cessation of the polymerization (Table 2).

The molecular weight of the purified PEDs was also estimated by ¹H-NMR from the relative peak intensities at δ=4.06 (CH₂O) and δ=3.65 (CH₂OH). The results are listed in Table 2. The difference with the GPC results is ascribed to hydrodynamic volume and GPC calibration considerations.

The GPC and ¹H-NMR data indicate that the polymerization reaction was effectively controlled by the induction of a stoichiometric imbalance at judicious times. As shown by the GPC results (Table 2). PEDs with target Mₙ values (between 1000 and 6000 g/mol) and a consistent PDI of ˜1.4 were achieved with yields as high as 77%.

Table 2 shows molecular weights obtained for PEDs by GPC and ¹H-NMR. Crude: before purification, Purified: after purification, Weight average molecular weight: M_{w} (g/mol), Number average molecular weight: Mₙ (g/mol), polydispersity index: PDI and yield (%) of PEDs after purification. t_{E} (h): time at which extra ND was added and t_{E}+1 h: one hour after extra diol was added, t_{Total}(h): total reaction time. The uncertainties attached to molecular weight, PDI and yield are better than 211 g/mol, 0.1 and 5.0% respectively.

TABLE 2

| | Crude | | | Purified | | | | | | | |
|---|---|---|---|---|---|---|---|---|---|---|---|
| | Mₙ at | | | | | Mₙ | | | | | |
| | t_{E} | t_{E} + 1 h | t_{Total} | M_{w} | PDI | (Pl) | M_{w} | Mₙ | PDI | M_{n (NMR)} | Yield |
| PED-1 h | 660 | 1420 | 2153 | 5060 | 2.42 | 3290 | 8400 | 6000 | 1.40 | 2370 | 67 |
| PED-3 h | 2090 | 1760 | 1979 | 5090 | 2.57 | 3030 | 6930 | 4780 | 1.45 | 1850 | 77 |
| PED-5 h | 2320 | 1840 | 2197 | 5690 | 2.59 | 3930 | 8450 | 5870 | 1.44 | 2240 | 66 |
| PED-7 h | 2610 | 1650 | 1701 | 3350 | 1.97 | 2670 | 4450 | 3070 | 1.45 | 1470 | 54 |

### Structural Characterization of TPEU Elastomers

¹H-NMR and FTIR Results

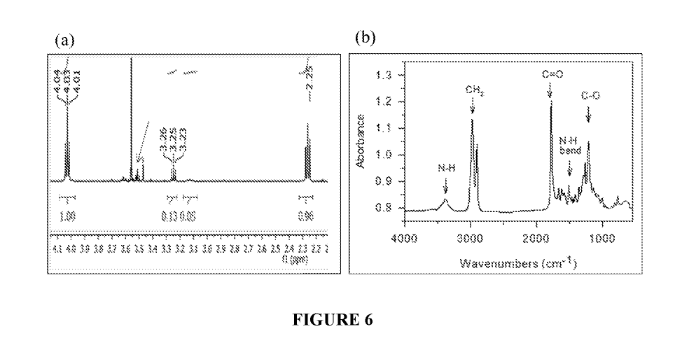

The TPEUs that were soluble in deuterated chloroform were characterized by ¹H-NMR; whereas TPEUs such as PU2.1 that were insoluble in all deuterated solvents were characterized by FTIR. ¹H-NMR spectrum of PU1.1, an example of TPEUs soluble in deuterated chloroform, is given in FIG. 6a. The FTIR spectrum of PU2.1 at 24 h of polymerization, an example of TPEUs insoluble in all deuterated solvents is presented in FIG. 6b.

The chemical shifts characteristic of methylene groups adjacent to the amide group (3.23 ppm), the alkyl oxygen (CH₂O, 4.01 ppm) and the carbonyl in the ester and urethane groups (CH₂C═O, 2.25 ppm), confirm the formation of the ester-urethane linkage (FIG. 6a). The presence of diol is noted from the chemical shift between 3.55 and 3.65 ppm (marked with an arrow in FIG. 6a) for methylene protons adjacent to the hydroxyl groups indicating that PED terminated TPEUs were formed. PU1.7 which was partially soluble in CDCl₃, but showed a lower peak intensity for the methylene protons adjacent to the hydroxyl group indicating a diminishing PED terminal content with increasing NCO:OH ratio.

Characteristic absorbance values of FIG. 6b for the carbonyl stretch of the ester and the urethane group at 1731 cm⁻¹, N—H bend of amide II (1527 cm⁻¹), C—O bend for amide III (1225 cm⁻¹) overlapped by the C—O deformations of ester group at 1223 cm⁻¹ and 1164 cm⁻¹ confirmed the formation of TPEUs. The single sharp peak at 3331 cm⁻¹ for the N—H group is indicative of a well formed hydrogen-bonded urethane segment, indicating the presence of NCO terminated TPEUs.

Effect of NCO:OH Ratio and Polymerization Time on Solubility and Molecular Weight

The TPEUs which were soluble in CHCl₃ were analyzed by GPC for molecular weight and PDI. Table 3 summarizes the molecular weight parameters for the TPEUs.

Table 3: shows solubility and GPC results for TPEUs with varying polymerization time and NCO:OH ratios. M_{w}: weight average molecular weights in g/mol, t: polymerization time (h), PDI: polydispersity index, PS: Partially soluble, I: Insoluble.

TABLE 3

| | M_{w} | | | | PDI | | | |
|---|---|---|---|---|---|---|---|---|
| t | PU1.1 | PU1.7 | PU2.1 | PU2.1* | PU1.1 | PU1.7 | PU2.1 | PU2.1* |
| 1 | — | 41788 | I | 37410 | — | 2.48 | — | 3.46 |
| 2 | 32320 | — | I | 41434 | 2.98 | — | — | 3.65 |
| 3 | 32828 | 50484 | I | 43933 | 3.07 | 2.51 | — | 3.63 |
| 4 | 35569 | 53698 | I | 64080 | 3.31 | 2.79 | — | 4.88 |
| 5 | — | 69495 | I | 625,988 | — | 2.96 | — | 36.6 |
| 6 | — | PS | I | PS | — | — | — | — |
| 24 | 66041 | PS | I | I | 2.29 | — | — | — |

*Crude samples extracted directly from the reaction mixture.

From the GPC results (Table 3) it is evident that molecular weight scaled with NCO:OH ratio and polymerization time; explaining the decreasing solubility of the TPEUs in CHCl₃. The increasingly restricted solubility of the TPEUs with stoichiometric ratio and polymerization time indicates a strong impact of these parameters on the intermolecular bonding. This trend in the (in)solubility of the TPEUs is analogous to what was observed for polyethylene, the most widely used thermoplastic, attributed to an increasing contribution of van der Waals forces. Also, the alternating m,n polyurethane [(O—(CH₂)ₘ—OC(O)—(CH₂)ₙ—(O)CO—(CH₂)ₘ—OC(O)—NH—(CH₂)ₙ—NH—C(O)] structure of the TPEUs (m=9 and n=7), presents long aliphatic spacers of similar sequence, restricting solubility due to linear chain stacking.

To test if there was any influence of chemical cross-linking due to a high NCO:OH ratio and long polymerization time on solubility, crude samples of PU2.1 were extracted from an ongoing reaction and tested for solubility in CHCl₃. The crude samples which were extracted until 5 hours were soluble, indicating the absence of chemical cross-links. The samples collected after 5 hours were gel-like and insoluble in CHCl₃. The molecular weight and PDI of the soluble samples were determined by GPC. The GPC data for these samples are listed under PU2.1* in Table 3. As shown in Table 3, M_{w} which increased relatively moderately up to 4 hours increased ten folds at 5 hours. The suggested trend points to exceptionally high molecular weight at longer polymerization times explaining the solubility behavior of the TPEUs that were obtained at high NCO:OH ratio and extended polymerization times.

The TPEU prepared with an NCO:OH ratio of 1.1 in the present work (PU1.1) presented a M_{w} which is double of that obtained previously in our laboratory for TPEU prepared with a similar NCO:OH ratio with the same entirely lipid-based ingredients. The difference in molecular weight and ensuing physical properties is explained by differences in both the starting PED monomers and the polymerization conditions. The two works highlight the importance of optimization of the synthesis of the monomers as well as the control of the reaction of these monomers with diisocyanates for the manufacturing of functional entirely lipid-derived TPEUs.

Effect of NCO:OH Ratio and Polymerization Time on Intermolecular Bonding

The carbonyl absorption bands were deconvoluted into three Gaussian peaks, corresponding to the free (1731 cm⁻¹) and hydrogen-bonded disordered (1715 cm⁻¹) and ordered (1690 cm⁻¹) carbonyl groups. The iterative least squares test (chi square value, 1×E-6) was run with varying position (frequency), width at half-height and height of the three peaks. The residual values for all fits were better than 2 percent.

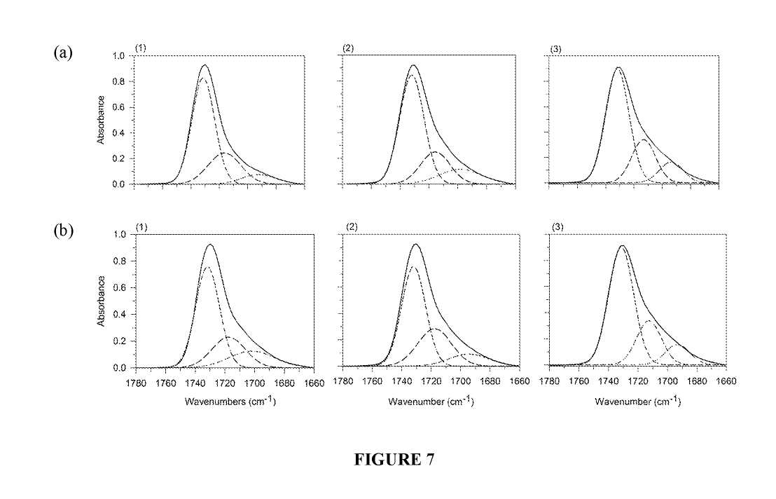

FIG. 7a (1-3) shows the carbonyl group band envelope and deconvolution results for PU1.1, PU1.7 and PU2.1, respectively, and FIG. 7b (1-3) shows those of PU2.1 at 2, 4 and 18 h, respectively.

The change in the relative intensities shown in FIG. 7 of the free (uppermost dashed curve), disordered (middle dashed curve) and ordered (lowermost dashed curve) hydrogen-bonded peaks reflects the participation of the carbonyl group in urethane-urethane and urethane-ester hydrogen bonding interactions with increasing NCO content and polymerization time. For example, the calculated full width at half maximum of the hydrogen-bonded carbonyl peaks lost two thirds of its value from PU1.1 to PU2.1 and almost halved in PU2.1 from 2 h to 24 h suggesting that well resolved urethane segments were progressively formed as the NCO content was increased or as polymerization time was extended.

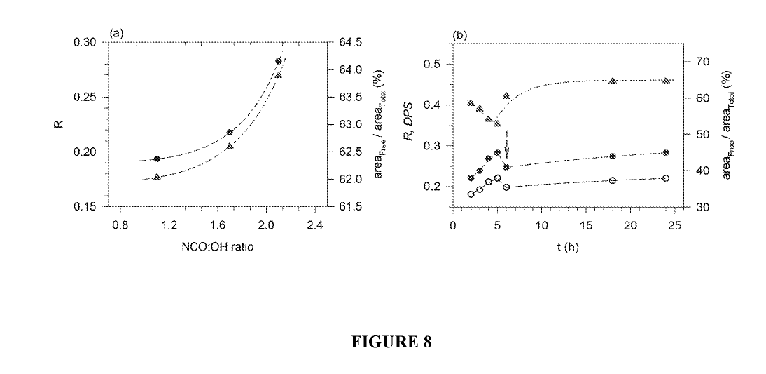

The concurrent trends observed for the hydrogen bonding index R and for the relative area of the free carbonyl groups (filled circle and triangle shown in FIG. 8a or NCO:OH ratio and in FIG. 8b for polymerization time) reveals the direct relationship between the van der Waals forces with the variation of molecular weight with NCO:OH ratio and polymerization time.

The linear increase of R and hence also DPS from t=1 to 5 h (filled circle and empty circle, respectively, in FIG. 8b) accompanied with a decrease of free carbonyl groups (filled triangle in FIG. 8b) is the result of the self-aggregation at low molecular weight of urethane segments due to hydrogen bonding in an environment of un-entangled chains; the process which leads to urethane and polyester phase separation. The relative decrease of R and increase of the free versus the hydrogen-bonded carbonyl groups afterwards is the manifestation of the dispersion of the urethane segments in the growing polyester matrix which offsets the influence of the hydrogen-bonded carbonyl groups. This dispersion promotes the urethane-ester interactions leading to phase mixing as shown by the singular drop of R and DPS after 5 hours of polymerization (arrow in FIG. 8b). Note that a plateau was reached after 18 hours of polymerization for R, DPS and A_{f} indicating a saturation effect. These results point to the dilution of hydrogen bonding by the increasing van der Waals contributions in the TPEUs; thus explaining their development towards polyethylene-like behavior as shown with solubility at high NCO:OH ratio and long polymerization times.

### Thermal Transition Behavior for TPEUs

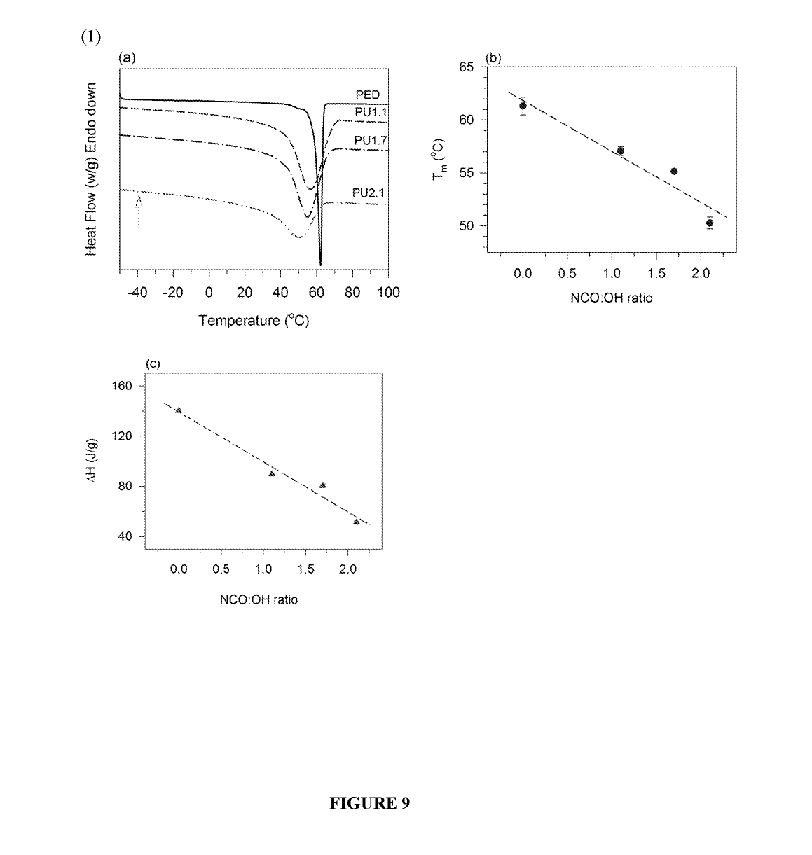

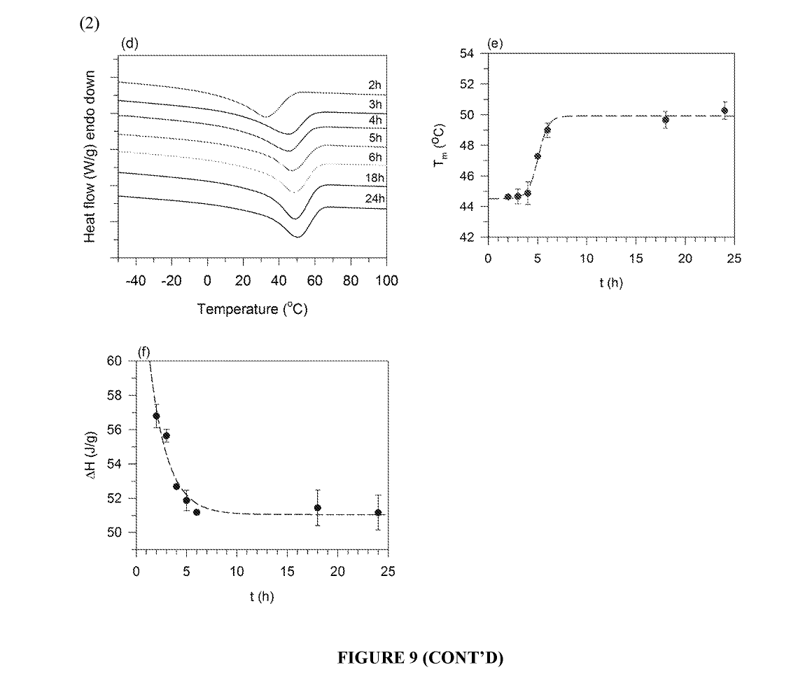

Like many physical properties, the thermal properties of polymers are determined by their structure and molecular weight. FIG. 9 shows the DSC melting curves obtained from the second heating cycle for the PED-3h and TPEUs prepared in this work.

As evident from FIG. 9a the thermograms of all TPEUs prepared in this work presented one broad endotherm ascribed to the melting of the polyester segment. The comparison with the sharp melting endotherm of the PED suggests that the crystals of the TPEUs are less organized. The steady shift to lower temperatures and decrease of the enthalpy of the melting peak with increasing NCO:OH ratio (Figures b and c.) is attributable to the decreasing influence of the PED-3h content. The Tₘ versus polymerization time shows an S-shaped sigmoidal function typical of so-called “population growth rate” trends (FIG. 9e). It shows an “augmentation” pattern of density that increases slowly initially, then increases rapidly, but then, as limiting factors are encountered, the rate of increase declines until a limit is approached asymptotically. This behavior is related to the growth of molecular weight/urethane phase and subsequent crystallinity.

The evolution of Tₘ with polymerization time corresponds to that of the molecular weight as determined by GPC (Table 3). The plateau observed for Tₘ after 5 hours indicated that the TPEU molecular weight has reached the critical value for entanglement. This result is of practical importance for the processing of thermoplastic materials wherein a desired temperature of melting can be achieved by controlling the degree of polymerization associated with polymerization time.

The exponential decrease of enthalpy of melt with polymerization time shown in FIG. 9f is the result of a decrease in the crystallinity of the TPEUs. The variation of enthalpy with polymerization time mimics that of linear polyethylene versus molecular weight reiterating the solubility behavior (Table 3) and the dilution of hydrogen bonding by the increasing van der Waals interactions as observed by FTIR (FIG. 8).

A weak T_{g} at ˜−37 to −40° C. was detected in the PU2.1 samples extracted after 5 h (marked with a red arrow in FIG. 9a for PU2.1 at 24 h) due to sufficiently large free volume resulting from the increase of molecular weight. A consistent T_{g} of −39° C. was achieved after 6 h of polymerization. This value is comparable to those of ultra-high molecular weight partially lipid-derived TPEU elastomers made from lipid-derived HPMDI and petroleum-based polyethylene adipate diol (PEAD) by and those of commercially available renewable polyester-based TPEUs Bio TPU PEARLTHANE ECO D12T85 made by Merquinza. The degree of polymerization after 6 hours was sufficiently high and that the molecular weight of the TPEUs exceeded the necessary value for high performance.

The trends observed in the melting behavior of the TPEUs are explained by the changes in their structure and molecular weight. The end group of a polymer affects physical properties, if the end-group chemical structure differs from that of the main polymer chain. In the case of TPEUs with increasing NCO content, PEDs which had zero NCO content presented the highest melting temperature and crystallinity as shown by the peak temperature (Tₘ) and enthalpy (ΔH) in FIG. 9b and -c, respectively. With the increase in NCO:OH ratio and the concomitant reduction in PED content, the PED chain packing was increasingly disrupted by the urethane segments resulting in less organized crystals and therefore lower Tᵢₙ and enthalpy of melting. In parallel, as hydrogen bonding was increasingly diluted by the van der Waals forces associated with the higher molecular weight, the amorphous phase of the TPEUs increases leading to lowered crystallinity and thus enthalpy.

### Thermal Stability of TPEUs

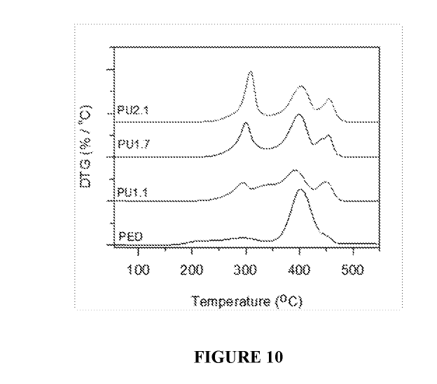

FIG. 10 shows the DTG profiles for the PED-3h and the TPEUs with varying NCO:OH ratio. As shown in FIG. 10, the TPEUs displayed a multistep degradation typical of linear polyurethanes. the weakest link, namely the C—NH urethane bond, was ruptured first around 260-330° C. followed by the random scission of the polyester chains at the alkoxy oxygen bond (C—O) between 350-445° C. and lastly the pyrolysis of the C—C bonds above 420° C. It is of note that there is no degradation due to aliphatic allophanate structures in the TPEUs which would otherwise show an onset of decomposition between 85 and 105° C. confirming the absence of crosslinked structures.

The decomposition parameters (T_{d(on5%)}, DTG peak temperatures and weight loss at the different stages of decomposition of PU2.1 did not vary with polymerization times indicating that the thermal decomposition of the TPEU was independent of molecular weight.

The onset temperature of decomposition of the TPEUs as measured at 5% mass loss (T_{d(on5%)}) decreased with increasing NCO:OH ratio (from 273° C. for PU1.1 to 262° C. for PU2.1). Such a decrease in the thermal stability is attributed to the increasing content of the weaker C—NH bond. The lower T_{d(on5%)} of PED-3h (214° C.) is attributed to the effect of the hydroxyl end-groups which reduce thermal stability as their content increases. With increasing NCO:OH ratio, the percent weight loss due to the C—NH groups increased from 18 to 35%, paralleled by a decrease in the weight loss due to C—O decomposition from 47 to 41% which matched the stoichiometric balance between diisocyanate and diol groups in the TPEUs. This also corresponds to the weight composition of HPMDI (8-17%) and PED-3h (92-83%) employed in the reactions.

The onset temperature of decomposition of the present TPEUs (265-271° C.) are comparable to that of partially lipid-derived ultra-high molecular weight TPEU elastomers reported elsewhere. Moreover, these materials have thermal stability temperatures well above the thermoplastic processing window of commercial TPEUs and can be processed by injection molding and extrusion.

### Tensile Properties of TPEUs

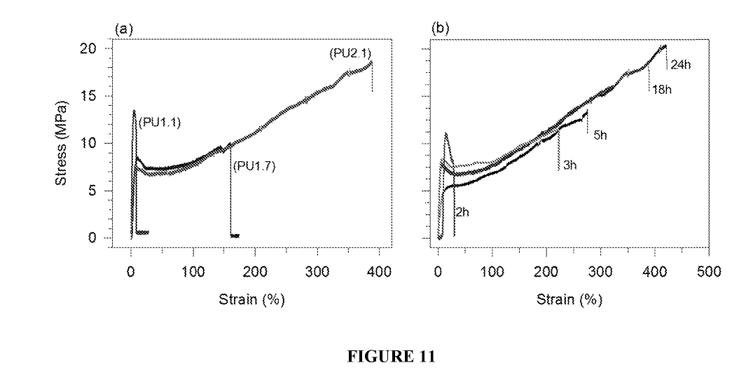

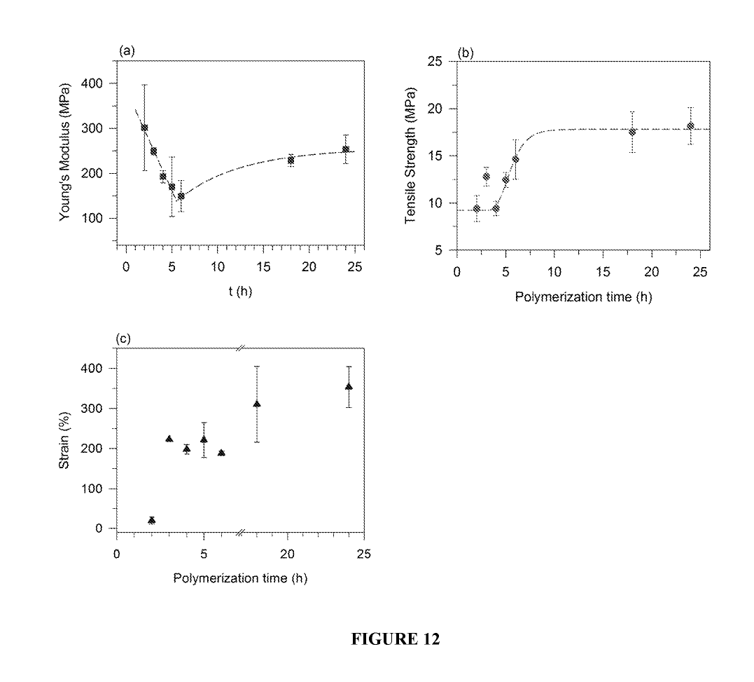

The stress-strain curves, measured at room temperature for PU1.1, PU1.7 and PU2.1 are shown in FIG. 11a, and the corresponding characteristics are listed in Table 4. The stress-strain curves obtained at selected polymerization times of PU2.1 are shown in FIG. 11b. The corresponding tensile properties are presented in FIG. 12.

The stress-strain data show that the TPEUs achieved gradually improved elastomeric properties. With the exception of PU1.1 (FIG. 11a) and the sample of PU2.1 extracted at 2 h (FIG. 11b) which exhibited a stress-strain behavior typical of brittle high-modulus plastics due to low molecular weight and high crystallinity, the stress-strain curves of all the TPEUs displayed an initial steep increase in stress followed by a distinct yielding indicative of some phase-mixing, further followed by strain hardening regions typical of elastomers. The elongation at break was improved dramatically with NCO:OH ratio, reaching 353% for PU2.1 (Table 4). This is a very large improvement to the previous entirely lipid-based TPEUs prepared also from PEDs and HPMDI which demonstrated an elongation at break of ˜3%, as recited in Hojabri et al. (cited above). The 6% value obtained for the maximum strain of PU1.1 of the present work is comparable to that of the TPEU prepared by Hojabri et al. and shows that the dampening effect of crystallinity due to high PED content and low molecular weight is dominant highlighting again the importance of controlling both the NCO:OH ratio and polymerization time.

Moreover, the extensibility of the entirely lipid-derived PU2.1 (353%) is comparable to commercially available petroleum-derived TPEUs such polyester based ESTANE 5715 Merquinza, which has a maximum strain of 350%.

PU1.7 which was insoluble in CHCl₃ is expected to have a much higher molecular weight than the 70,000 g/mol that it presented at 5 h (M_{w}, Table 3), demonstrated a lower elongation (150%) and modulus (231 MPa) than PU2.1 at 3 h (223% and 249 MPa, respectively) whose molecular weight before purification was 44,000 g/mol (Table 3). The effect of molecular weight was offset by the higher crystallinity of PU1.7, due to its higher PED content.

The tensile strength and Young's modulus of PU1.7 were lower than those of PU1.1 because of lower crystallinity stemming from a reduced PED content. In the case of PU2.1, the lower crystallinity was counterbalanced by the competing effect of the uncoiling of entangled chains at higher molecular weight enhancing the tensile strength, modulus as well as elongation at break. These results again highlight the importance of both the structure and molecular weight through the rigorous control of the NCO:OH ratio and the polymerization time in the design of functional entirely lipid-derived TPEUs. Table 4 recites the tensile properties of the TPEUs.

TABLE 4

| | M_{w} | Ultimate | Young's | Maximum |
|---|---|---|---|---|
| TPEU | (gmol⁻¹) | strength (MPa) | modulus (MPa) | strain (%) |
| PU1.1 | 66041 | 12.3 ± 1.0 | 482 ± 51 | 6.4 ± 1.2 |
| PU1.7 | — | 10.1 ± 0.3 | 231 ± 4 | 150.0 ± 9.7 |
| PU2.1 | — | 18.2 ± 1.9 | 253 ± 32 | 353.4 ± 51.0 |

The evolution of Young's modulus until 6 h shown in FIG. 12a reflect the steady increase in molecular weight of the TPEU and corresponding decrease in crystallinity. After 6 hours, however, the modulus increased and presented the typical saturation limit. This behavior is attributed to the increase in intermolecular forces associated with chain entanglements that increase in the polymer after its critical molecular weight of entanglements was reached. The maximum strain at break jumped from 20% for the sample extracted at 2 h to 223% for the sample extracted 1 hour later. This is attributed to the TPEU attaining the critical molecular weight required for high elongation. The elongation remains relatively unchanged for the following 3 hours, and then increased afterwards to reach also a saturation limit. This behavior is attributed to strain hardening caused by the orientation of high molecular weight chains which results in enhanced elongation at higher stress.

The increase in tensile strength of the TPEU with polymerization time is associated with the increase in molecular weight. The trend observed in the evolution of tensile strength versus polymerization time of FIG. 12b although not as well defined because of larger uncertainties is reminiscent of the S-shaped curve of Tₘ shown in FIG. 9d. It confirms the close link with molecular weight and establishes the same saturation limit.

Other structural features may be invoked to explain the trends observed in the mechanical properties of the TPEUs of the present work. The polyester segment crystals were probably acting as a physical reinforcing network similarly to what was reported for other polyester based polyurethanes with moderate crystallinity, resulting in higher ultimate strength, initial modulus and strain at break. A contributing factor may also be the absorption of deformation energy by the polyester segments through the unfolding of the isotropic crystalline lamellae.

### Hydrothermal Ageing Properties of TPEUs

Hydrothermal ageing was performed under accelerated hydrothermal conditions, i.e. at 80° C. from 1 to 30 days of immersion in water using protocol reported in Pretsch et al., Polymer Degradation and Stability, vol. 94(1), pp. 61-73 (2009).

For the TPEUs disclosed herein, the hydrothermal ageing significantly affected the morphological structure of the TPEUs resulting in erosion of soft and hard segments leading to a brittle failure. The continued deterioration of the crystallinity and associated mechanical properties of the TPEUs indicated that the TPEUs are easily fragmentable and can significantly biodegrade after a successful service life as shown from the degradation of molecular weight and deterioration of physical properties: (a) molecular weight degradation after 15 days of immersion—drop from 85,000 g/mol to 10,000 g/mol in 5 days; and (b) mechanical properties deteriorate under accelerated hydrothermal ageing conditions demonstrating a tensile half-life within 1 day of immersion rendering the TPEUs unable to withstand any tensile loads.

### CONCLUSIONS

Polyester diols (PED)s were synthesized by solvent-free melt condensation of lipid-derived azelaic acid and 1,9 nonanediol in the presence of a catalyst using a novel induced stoichiometric imbalance method. The molecular weight and PDI of the PEDs were controlled effectively by an initial stoichiometric imbalance and then later at selected reaction times by adding extra diol. PEDs with target molecular weights between 1000 and 6000 gmol⁻¹ with a narrow and consistent PDI of 1.4 and yields between 54 and 77% were achieved in reaction times as short as 5 h.

Entirely lipid-derived thermoplastic poly(ester urethane) (TPEU) elastomers were synthesized with the PED which showed a molecular weight closest to the industry standard and oleic acid derived aliphatic 1,7 heptamethylene diisocyanate (HPMDI). Very high molecular weights combined with a controlled phase separation and crystal structure were achieved by effectively optimizing the NCO:OH ratio and polymerization time. Most of the crude and all the purified TPEUs could not be dissolved in CHCl₃, THF and DMF, the most common organic solvents used for processing polyurethanes because of very high molecular weight and specific linear aliphatic structure. Furthermore, the TPEUs presented a very good thermal degradation stability with onsets of degradation higher than 265° C.

The optimization work allowed for the production of TPEUs with molecular weights larger than the critical value beyond which the physical properties reach saturation. For these TPEUs, the van der Waals contributions to the overall intermolecular interactions were revealed to be dominant and to dilute the effect of hydrogen bonding, resulting in polyethylene-like characteristics.

Predictive relationships were established between the melting characteristics such as the melting temperature of the TPEUs and NCO:OH or polymerization time. Such data are directly related to the degree of polymerization and its control. The relationship in fact allows the production of processable thermoplastic materials with desired melting temperatures. Predictive relationships were also established between the mechanical properties of the TPEUs and NCO:OH or polymerization time, also allowing for the design of elastomers with customized properties. The mechanical properties of the TPEUs of the present work were notably enhanced compared to the TPEUs also based on lipid-derived HPMDI and PED synthesized previously in our laboratory. Their properties compare very favorably with those of analogous partially lipid-derived polymers of ultra-high molecular weight. Their extensibility (353%) is even comparable to that of commercially available entirely petroleum-derived TPEU.

Most importantly, the study demonstrates that the optimization of both NCO:OH ratio and polymerization time is indispensable to achieving entirely lipid-based TPEUs with the optimal molecular weight and crystal structure combination necessary for best thermal and mechanical properties.

The hydrothermal ageing was shown to significantly affect the morphological structure of the TPEU in a complex manner. Three phases were observed in the hydrolytic degradation of the TPEU elastomers. The degradation started with the scission of the soft segments; followed by a step in which although the erosion resulted in smaller fragments, they reorganized without diffusing out of the material in what is known as “chemicrystallization”, and in lastly the acceleration of the degradation of the ester phase leading to a brittle failure. The structure of the phase separated TPEU was revealed to offer a somehow higher protection against thermal ageing through its nanoscale crystalline load bearing phase than the continuous structure of the one-phase TPEU.

The continued deterioration of the mechanical properties of the TPEUs was related to the loss of molecular weight and PDI and directly correlated to the drop in crystallinity as revealed by DSC. Noticeably, the TPEU of the present disclosure showed a very short tensile half-life, indicating that they are easily fragmentable and can significantly biodegrade after a successful service life.

### REFERENCES

1. Szycher, M., Medical Applications, in Szycher's Handbook of Polyurethanes, Second Edition. 2012, CRC Press. p. 633-670.
2. Lligadas, G., et al., Renewable polymeric materials from vegetable oils: a perspective. Materials Today, 2013. 16(9): p. 337-343.
3. Miao, S., et al., Vegetable-oil-based polymers as future polymeric biomaterials. Acta biomaterialia, 2014. 10(4): p. 1692-1704.
4. Hojabri, L., X. Kong, and S. S. Narine, Fatty acid-derived diisocyanate and biobased polyurethane produced from vegetable oil: synthesis, polymerization, and characterization. Biomacromolecules, 2009. 10(4): p. 884-891.
5. Li, S., et al., Maximizing the utility of biobased diisocyanate and chain extenders in crystalline thermoplastic segmented polyester urethanes: Effect of polymerization protocol. Unpublished, Submitted to Polymer, 2014.
6. More, A. S., et al., Novel fatty acid based di-isocyanates towards the synthesis of thermoplastic polyurethanes. European Polymer Journal, 2013. 49(4): p. 823-833.
7. Petrović, Z. S., Y. Xu, and W. Zhang, Segmented polyurethanes from vegetable oil-based polyols. Polymer Preprints, 2007. 48(2): p. 852-853.
8. Charlon, M., et al., Synthesis, structure and properties of fully biobased thermoplastic polyurethanes, obtained from a diisocyanate based on modified dimer fatty acids, and different renewable diols. European Polymer Journal, 2014. 61: p. 197-205.
9. Hojabri, L., X. Kong, and S. S. Narine, Functional thermoplastics from linear diols and diisocyanates produced entirely from renewable lipid sources. Biomacromolecules, 2010. 11(4): p. 911-918.
10. Odian, G., Step Polymerization. 4th ed. Principles of Polymerization. 2004, Hoboken, N.J.: Wiley-Interscience. 39-197.
11. Su, W.-F., Principles of Polymer Design and Synthesis. 2013: Springer.
12. Flory, P. J., Tensile strength in relation to molecular weight of high polymers. Journal of the American Chemical Society, 1945. 67(11): p. 2048-2050.
13. Szycher, M., Szycher's Handbook of Polyurethanes. 1999: CRC.
14. Ionescu, M., Chemistry and technology of polyols for polyurethanes. Rapra Technology ed. Chemistry and technology of polyols for polyurethanes. 2005, Shrewsbury, UK: iSmithers Rapra Publishing. 263-284.
15. Hojabri, L., et al., Synthesis and physical properties of lipid-based poly(ester-urethane)s, I: Effect of varying polyester segment length. Polymer, 2012.
16. Saralegi, A., et al., Thermoplastic polyurethanes from renewable resources: effect of soft segment chemical structure and molecular weight on morphology and final properties. Polymer International, 2013. 62(1): p. 106-115.
17. Xu, Y., et al., Morphology and properties of thermoplastic polyurethanes with dangling chains in ricinoleate-based soft segments. Polymer, 2008. 49(19): p. 4248-4258.
18. Kuran, W., et al., New route to oligocarbonate diols suitable for the synthesis of polyurethane elastomers. Polymer, 2000. 41(24): p. 8531-8541.
19. Odian, G., Principles of polymerization. 2004: John Wiley & Sons.
20. Hiemenz, P. C., Polymer chemistry: the basic concepts. Polymer chemistry: the basic concepts. 1984, New York: Marcel Dekker. 273-384.
21. Vaidya, U. and V. Nadkarni, Polyester polyols for polyurethanes from PET waste: kinetics of polycondensation. J Appl Polym Sci, 1988. 35(3): p. 775-785.
22. Jose, J., et al., Influence of monomeric and polymeric structure on the physical properties of thermoplastic polyesters derived from hydroxy fatty acids. Polymer International, 2014. 63(11): p. 1902-1911.
23. Li, Y., et al., Synthesis and characterization of controlled molecular weight disulfonated poly (arylene ether sulfone) copolymers and their applications to proton exchange membranes. Polymer, 2006. 47(11): p. 4210-4217.
24. Peebles Jr, L., Sequence length distribution in segmented block copolymers. Macromolecules, 1974. 7(6): p. 872-882.
25. Buist, J. M. and H. Gudgeon, Advances in polyurethane technology: by a group of specialists from Imperial Chemical Industries Ltd. 1968: Wiley.
26. Sharmin, E. and F. Zafar, Polyurethane: An Introduction. 2012: INTECH Open Access Publisher.
27. Valuev, V. I., et al., Relationship between molecular parameters of linear segmented polyurethanes and synthesis conditions. Russian Journal of Applied Chemistry, 2009. 82(6): p. 1052-1055.
28. Seymour, R., G. Estes, and S. Cooper, Infrared studies of segmented polyurethane elastomers. I. Hydrogen bonding. Macromolecules, 1970. 3(5): p. 579-583.
29. Coleman, M. M., et al., Hydrogen bonding in polymers. 4. Infrared temperature studies of a simple polyurethane. Macromolecules, 1986. 19(8): p. 2149-2157.
30. Pretsch, T., I. Jakob, and W. Müller, Hydrolytic degradation and functional stability of a segmented shape memory poly (ester urethane). Polymer degradation and stability, 2009. 94(1): p. 61-73.
31. de Jong, S. J., et al., New insights into the hydrolytic degradation of polylactic acid): participation of the alcohol terminus. Polymer, 2001. 42(7): p. 2795-2802.
32. Zhao, Y.-F., et al., Synthesis and characterization of diblock copolymers based on crystallizable poly (ε-caprolactone) and mesogen-jacketed liquid crystalline polymer block. Polymer, 2005. 46(14): p. 5396-5405.
33. McKiernan, R. L., S. P. Gido, and J. Penelle, Synthesis and characterization of polyethylene-like polyurethanes derived from long-chain, aliphatic α, ω-diols. Polymer, 2002. 43(10): p. 3007-3017.
34. Mandelkern, L., A. Allou Jr, and M. Gopalan, Enthalpy of fusion of linear polyethylene. Journal of Physical Chemistry, 1968. 72(1): p. 309-318.
35. Salamone, J. C., Concise polymeric materials encyclopedia. Vol. 1. 1998: CRC press.
36. Muggli, M., et al., End-group effect on physical aging and polymer properties for poly (ether sulfones). Journal of Polymer Science Part B: Polymer Physics, 2003. 41(22): p. 2850-2860.
37. Chattopadhyay, D. and D. C. Webster, Thermal stability and flame retardancy of polyurethanes. Prog. Polym. Sci, 2009. 34(10): p. 1068-1133.
38. Corcuera, M., et al., Microstructure and properties of polyurethanes derived from castor oil. Polymer degradation and stability, 2010. 95(11): p. 2175-2184.
39. Bueno-Ferrer, C., M. Garrigós, and A. Jiménez, Characterization and thermal stability of poly (vinyl chloride) plasticized with epoxidized soybean oil for food packaging. Polymer degradation and stability, 2010. 95(11): p. 2207-2212.
40. Malcolm, P. S., Polymer chemistry: an introduction. Oxford University Press, New York, 1999: p. 87-91.
41. Skarja, G. A., The development and characterization of degradable, segmented polyurethanes containing amino acid-based chain extenders. 2001.
42. Liow, S., et al., Enhancing mechanical properties of thermoplastic polyurethane elastomers with 1,3-trimethylene carbonate, epsilon-caprolactone and l-lactide copolymers via soft segment crystallization, eXPRESS Polym. Lett, 2011. 5: p. 897-910.
43. Toki, S., et al., Structure evolution during cyclic deformation of an elastic propylene-based ethylene propylene copolymer. Macromolecules, 2006. 39(10): p. 3588-3597.
44. Chu, C. (1981). Hydrolytic degradation of polyglycolic acid: tensile strength and crystallinity study. Journal of applied polymer science 26(5): 1727-1734.
45. Furukawa, M., T. Shiiba, et al. (1999). Mechanical properties and hydrolytic stability of polyesterurethane elastomers with alkyl side groups. Polymer 40(7): 1791-1798.
46. John, S. (1999). Compositional and Failure Analysis of Polymers, John Wiley & Sons.
47. Li, S., J. Jose, et al. (2014). Maximizing the utility of biobased diisocyanate and chain extenders in crystalline thermoplastic segmented polyester urethanes: Effect of polymerization protocol. Polymer 55(26): 6764-6775.
48. Mondal, S. and D. Martin (2012). Hydrolytic degradation of segmented polyurethane copolymers for biomedical applications. Polymer degradation and stability 97(8): 1553-1561.
49. Nakamae, K., K. Yamaguchi, et al. (1996). Lifetime expectancy of polyurethane binder as magnetic recording media. International journal of adhesion and adhesives 16(4): 277-283.
50. Padsalgikar, A., E. Cosgriff-Hernandez, et al. (2015). Limitations of predicting in vivo biostability of multiphase polyurethane elastomers using temperature-accelerated degradation testing. Journal of Biomedical Materials Research Part B-Applied Biomaterials 103(1): 159-168.
51. Pretsch, T., I. Jakob, et al. (2009). Hydrolytic degradation and functional stability of a segmented shape memory poly (ester urethane). Polymer degradation and stability 94(1): 61-73.
52. Saralegi, A., L. Rueda, et al. (2013). Thermoplastic polyurethanes from renewable resources: effect of soft segment chemical structure and molecular weight on morphology and final properties. Polymer International 62(1): 106-115.
53. Shetranjiwalla, S., S. Li, et al. (2015). Imparting elastomeric properties to entirely lipid-derived thermoplastic poly(ester urethane)s: Molecular weight control. Submitted to Polymer.
54. Thompson, D. G., J. C. Osborn, et al. (2006). Effects of hydrolysis-induced molecular weight changes on the phase separation of a polyester polyurethane. Polymer degradation and stability 91(12): 3360-3370.
55. Xu, Y., Z. Petrovic, et al. (2008). Morphology and properties of thermoplastic polyurethanes with dangling chains in ricinoleate-based soft segments. Polymer 49(19): 4248-4258.

1. A polymer composition, comprising one or more polymers having constitutional units according to formula (I): 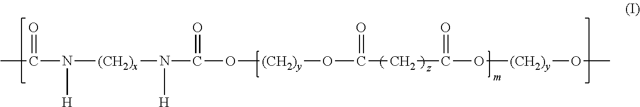
wherein:
x is an integer from 2 to 40;
y is an integer from 9 to 22;
z is an integer from 7 to 22; and
m is an integer from 2 to 50;
wherein the one or more polymers in the composition have a weight-average molecular weight (M_{w}) of at least 44,000 g/mol.

2. The polymer composition of claim 1, wherein x is an integer from 2 to 30, or from 3 to 20, or from 4 to 15, from 5 to 10, or x is 7.

3. The polymer composition of claim 1, wherein y is an integer from 9 to 20, from 9 to 18, or from 9 to 16, or y is 9.

4. The polymer composition of claim 1, wherein z is an integer from 7 to 20, from 7 to 18, or from 7 to 16 or 7.

5. The polymer composition of claim 1, wherein m is an integer from 2 to 25, or from 3 to 20, or from 4 to 15, or from 5 to 10.

6. The polymer composition of claim 1, wherein the one or more polymers in the composition have a weight-average molecular weight (M_{w}) of at least 80,000 g/mol, or at least 100,000 g/mol, or at least 200,000 g/mol, or at least 300,000 g/mol, or at least 400,000 g/mol, or at least 500,000 g/mol, or at least 600,000 g/mol.

7. The polymer composition of claim 1, wherein the constitutional units according to formula (I) are formed from lipid-derived monomers.

8. The polymer composition of claim 1, wherein the one or more polymers have a renewable carbon content of 100%.

9. The polymer composition of claim 1, wherein intermolecular hydrogen bonding forced in the one or more polymers are diluted by dominant van der Waals forces.

10. The polymer composition of claim 1, wherein the polymer composition exhibits one or more of the following properties:
an initial modulus ranging from 115 MPa to 533 MPa;
an ultimate tensile strength ranging from 8.6 MPa to 20.1 MPa;
an ultimate elongation at break ranging from 5.2% to 404%.
an onset of melting temperature ranging from 14.6° C. to 31.5° C.;
an offset temperature ranging from 57.9° C. to 63.3° C.;
a peak melting temperature ranging from 44.9° C. to 50.6° C.; or
a glass transition temperature ranging from −43° C. to −35° C.

11. The polymer composition of any one of claim 1, wherein the constitutional units of formula (I) make up at least 80% by weight, or at least 90% by weight, or at least 95% by weight, or at least 97% by weight, or at least 98% by weight, or at least 99% by weight of the one or more polymers.

12. The polymer composition of claim 1, wherein, upon immersing the one or more polymers in water at 80° C. for 30 days, the one or more polymers degrade into one or more hydrolyzed products, the one or more hydrolyzed products having a weight-average molecular weight (M_{w}) of no more than 4000 g/mol.

13. A polymer composition, comprising one or more urethane polymers formed from a first reaction mixture, which comprises C₂₋₄₀ diisocyanates and dihydroxyl-terminated polyesters;
wherein the dihydroxyl-terminated polyesters are formed from a second reaction mixture, which comprises C₉₋₂₂ diols and C₇₋₂₂ dicarboxylic acids or esters thereof; and
wherein the dihydroxyl-terminated polyesters in the first reaction mixture have a number-average molecular weight (Mₙ) of at least 3000 g/mol.

14. The polymer composition of claim 13, wherein the C₂₋₄₀ diisocyanates are C₂₋₃₀ diisocyanates, or C₃₋₂₀ diisocyanates, or C₄₋₁₅ diisocyanates, or C₅₋₁₀ diisocyanates, or 1,7-heptamethylene diisocyanate.

15. The polymer composition of claim 13, wherein the C₉₋₂₂ diols are C₉₋₂₀ diols, or C₉₋₁₈ diols, C₉₋₁₆ diols, or 1,9-nonanediol.

16. The polymer composition of claim 13, wherein the C₇₋₂₂ dicarboxylic acids or esters thereof are C₇₋₂₀ dicarboxylic acids, or C₇₋₁₈ dicarboxylic acids, C₇₋₁₆ dicarboxylic acids, or esters of thereof, or azelaic acid or esters thereof.

17. The polymer composition of claim 13, wherein the dihydroxyl-terminated polyesters in the first reaction mixture have a number-average molecular weight (Mₙ) of at least 3500 g/mol, or at least 4000 g/mol, or at least 4500 g/mol.

18. The polymer composition of claim 13, wherein the one or more urethane polymers in the composition have a weight-average molecular weight (M_{w}) of at least 80,000 g/mol, or at least 100,000 g/mol, or at least 200,000 g/mol, or at least 300,000 g/mol, or at least 400,000 g/mol, or at least 500,000 g/mol, or at least 600,000 g/mol.

19. The polymer composition of claim 13, wherein the polymer composition exhibits one or more of the following properties:
an initial modulus ranging from 115 MPa to 533 MPa;
an ultimate tensile strength ranging from 8.6 MPa to 20.1 MPa; or
an ultimate elongation at break ranging from 5.2% to 404%.

20. The polymer composition of claim 13, wherein the polymer composition reaches its tensile half-life in no more than one day upon immersion in water at 80° C.
